(19) United States
(12) Patent Application Publication
(10) Pub. No.: US 2026/0366454 A1
(43) Pub. Date: Nov. 19, 2026

(54) TWO-STROKE ENGINE

(71) Applicant: YAMABIKO CORPORATION, Tokyo (JP)

(72) Inventors: Kuniyoshi ETO, Tokyo (JP); Masaru NOZAWA, Tokyo (JP)

(73) Assignee: YAMABIKO CORPORATION, Tokyo (JP)

(21) Appl. No.: 19/574,509

(22) Filed: Mar. 23, 2026

(30) Foreign Application Priority Data
May 16, 2025 (JP) 2025-082396

(51) Int. Cl. F02B 25/14; F02B 75/02

(52) U.S. Cl. CPC F02B 25/14; F02B 75/02; F02B 2075/025

(57) ABSTRACT

A two-stroke engine of the present invention includes a recess 12 leading to a cylinder chamber 10. The recess 12 has a passage length L and includes a tunnel portion that connects an opening 12a and a deep portion 12b of the recess 12. A spark plug 14 is disposed in the deep portion 12b of the recess 12, and a firing portion 54 of the spark plug 14 and its surroundings can be heated by a preheating member 16.

### BACKGROUND OF THE INVENTION

The present application claims foreign priority based on Japanese Patent Application No. 2025-082396, filed May 16, 2025, the contents of which is incorporated herein by reference herein.

The present invention relates to a two-stroke engine, and more particularly to a two-stroke engine that can use a variety of fuels, including not only gasoline but also kerosene, diesel, and alcohol fuels (methanol, ethanol).

Generally, spark-ignition two-stroke engines and spark-ignition four-stroke engines are developed based on the premise that they use gasoline as fuel. Two-stroke engines have the advantage of having fewer parts because they do not have a valve train. The two-stroke engine disclosed in JP2022-45147A has a sub-chamber communicating with a main combustion chamber formed by a piston, and a spark plug is disposed in the sub-chamber. The sub-chamber and the main combustion chamber are separated by a partition wall having a plurality of small apertures formed therein, through which the sub-chamber and the main combustion chamber communicate with each other. When the air-fuel mixture is ignited in the sub-chamber, the pressure in the sub-chamber rises sharply, and the resulting pressure causes a flame to be ejected into the main combustion chamber, spreading in all directions through the plural small apertures in the partition wall.

As is well known, the operating process of a two-stroke engine consists of (i) compression stroke, which occurs when the piston ascends, and (ii) an expansion stroke, which occurs when the piston descends. Another expression to define the characteristics of a two-stroke engine is that it scavenges the combustion chamber with fresh gas (typically an air-fuel mixture) pre-compressed in the crankcase. Single-cylinder two-stroke engines, which are currently popular as power sources for portable working machines, include a carburetor, and the air-fuel mixture generated in the carburetor is supplied to the crankcase. The air-fuel mixture pre-compressed in the crankcase is then supplied to the combustion chamber, scavenging the combustion chamber with the air-fuel mixture.

A four-stroke engine has four independent strokes: (i) intake stroke, (ii) compression stroke, (iii) expansion stroke, and (iv) exhaust stroke. JP-S18(1943)-004909Y discloses a four-stroke engine capable of using various fuels, exemplifying not only gasoline but also diesel, heavy oil, and animal and vegetable oils as applicable fuels. The four-stroke engine has a subsidiary combustion chamber connected to the main combustion chamber via a communication passage. The communication passage extends orthogonal to the longitudinal direction of the subsidiary combustion chamber. That is, the main combustion chamber and the communication passage are connected in an L-shaped bend. The subsidiary combustion chamber has a fuel valve disposed at the boundary portion with the communication passage. This fuel valve has a valve head, and when the valve head separates from the valve seat, liquid fuel is supplied to the subsidiary combustion chamber. The fuel valve is driven by a camshaft, which is part of the four-stroke engine's valve train. An electric heating plug is disposed in the subsidiary combustion chamber, and the subsidiary combustion chamber is heated by the electric heating plug. A spark plug is disposed at the back of the subsidiary combustion chamber.

In the four-stroke engine of JP-S18(1943)-004909Y, the electric heating plug is disposed for the purpose of heating the subsidiary combustion chamber. This four-stroke engine operates according to the following process. Liquid fuel is supplied to the subsidiary combustion chamber heated by the electric heating plug, vaporizing and decomposing the liquid fuel at the same time. This produces a rich mixture in the subsidiary combustion chamber. The rich mixture in the subsidiary combustion chamber mixes with air in the main combustion chamber during the compression stroke. The mixture is then ignited by the spark plug. The flame in the subsidiary combustion chamber is ejected into the main combustion chamber through the communication passage.

JP2010-203428A discloses a four-stroke diesel engine that runs on diesel fuel. This four-stroke diesel engine includes a sub-chamber having a fuel injection valve. As is well known, the fuel injection valve injects fuel in the form of fine droplets. The sub-chamber communicates with the main combustion chamber via a narrow passage. In a four-stroke diesel engine with this configuration, diesel fuel injected into the sub-chamber is ignited and burns due to the heat of compression. As it expands, it flows into the main combustion chamber, where it continues to burn, driving the expansion stroke of the four-stroke engine.

### SUMMARY OF THE INVENTION

An object of the present invention is to provide a two-stroke engine that can use a variety of fuels while maintaining the characteristic of a two-stroke engine, that is, the small number of parts.

The present invention provides a two-stroke engine configured as follows. That is, the two-stroke engine according to the present invention includes:
a cylinder chamber in which a piston reciprocates;
an intake port that is opened and closed by the piston;
an exhaust port opened and closed by the piston;
scavenging passages communicating with a crankcase;
scavenging ports connected to the scavenging passages and opened and closed by the piston, wherein fresh gas is supplied from the intake port to the crankcase, the fresh gas pre-compressed in the crankcase being supplied to the cylinder chamber through the scavenging passages and the scavenging ports, thereby scavenging the cylinder chamber; and
a recess leading to the cylinder chamber, wherein the recess includes:
   an opening that opens to the cylinder chamber;
   a deep portion;
   a tunnel portion having a passage length and connecting the deep portion and the opening;
   a spark plug disposed in the deep portion; and
   a preheating member for heating a firing portion of the spark plug and its surroundings.

Other objects and advantages of the present invention will become apparent from the following detailed description of an embodiment.

### BRIEF DESCRIPTION OF THE DRAWINGS

FIG. 1 shows a schematic diagram for explaining the overall configuration of a two-stroke engine.

FIG. 2 shows a diagram for explaining two strokes of the two-stroke engine.

FIG. 3 shows a diagram illustrating an example of an engine body.

FIG. 4 shows a flowchart illustrating an example of engine control.

FIG. 5 shows a diagram illustrating another example of the engine body.

FIG. 6 shows a cross-sectional view of a recess forming attachment included in the engine body shown in FIG. 5.

FIG. 7 shows a diagram showing the results of a simulation of a cold start of a prototype.

### DETAILED DESCRIPTION OF THE PRESENT INVENTION

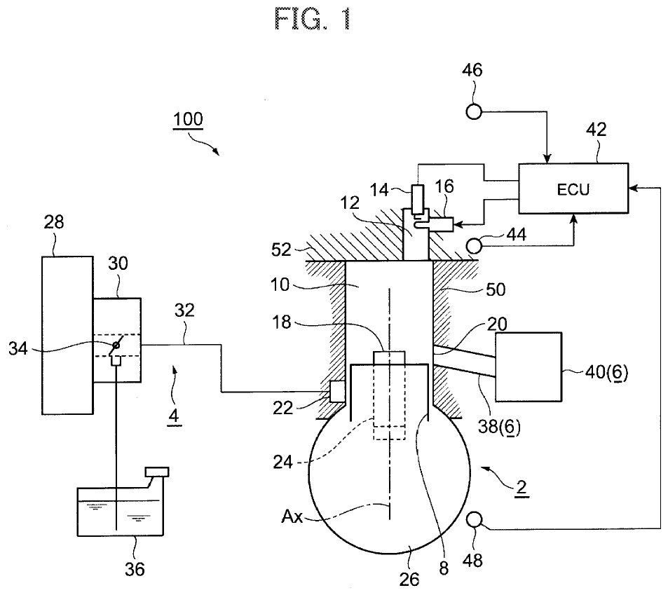

FIG. 1 is a schematic diagram of the overall configuration of a two-stroke engine. The two-stroke engine 100 includes an engine body 2, an intake system 4 that supplies outside air to the engine body 2, and an exhaust system 6 that exhausts burned gas from the engine body 2 to the outside. The engine body 2 shown in the figure is an air-cooled single-cylinder engine, but it may also be water-cooled or comprise plural cylinders. It may also be an opposed-piston two-stroke engine.

The engine body 2 has a cylinder chamber 10 in which a piston 8 reciprocates, and a recess 12 that opens to the top of the cylinder chamber 10. A spark plug 14 and a preheating member 16 are disposed at a back of the recess 12. Scavenging ports 18, an exhaust port 20, and an intake port 22 open to the cylinder chamber 10. These ports 18, 20, and 22 are opened and closed by the piston 8. The scavenging ports 18 communicate with a crankcase 26 via scavenging passages 24. The intake system 4 connected to the intake port 22 is composed of an air cleaner 28, a carburetor 30, and an intake pipe 32, and a throttle valve 34 is disposed in the carburetor 30.

Liquid fuel in a fuel tank 36 is supplied to the carburetor 30, where an air-fuel mixture is generated. The air-fuel mixture is supplied to the crankcase 26 through the intake pipe 32 and the intake port 22, and is pre-compressed in the crankcase 26. The pre-compressed air-fuel mixture is supplied to the cylinder chamber 10 through the scavenging passages 24 and the scavenging ports 18, and the air-fuel mixture entering the cylinder chamber 10 scavenges the cylinder chamber 10. The exhaust system 6 is composed of an exhaust pipe 38 connected to the exhaust port 20, and a silencer 40.

The fuel to be filled in the fuel tank 36 may be gasoline, kerosene, diesel, alcohol fuel (methanol, ethanol), or the like.

The two-stroke engine 100 has an electronic control unit (ECU) 42 that constitutes a control section, and signals are input to the ECU 42 from a temperature sensor 44 that detects the engine temperature, an engine start switch 46, and a sensor 48 that detects the crank angle of a crankshaft (not shown). The spark plug 14 and preheating member 16 are controlled by the ECU 42.

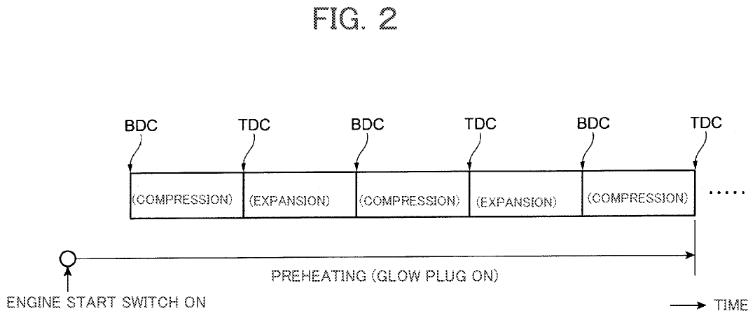

Referring to FIG. 2, the operating process of the two-stroke engine 100 is composed of (i) a compression stroke in which the piston 8 ascends from bottom dead center (BDC) to perform compression, and (ii) an expansion stroke in which the piston 8 descends from top dead center (TDC) to perform expansion. In this embodiment, “intake” is performed during the process in which the piston 8 ascends from bottom dead center, and “scavenging” is performed during the process in which the piston 8 descends from top dead center. These intake and scavenging operations are a typical example of a current two-stroke engine that is deployed and used in society, but the intake and scavenging operations in a two-stroke engine are not limited to the intake and scavenging operations in the embodiment.

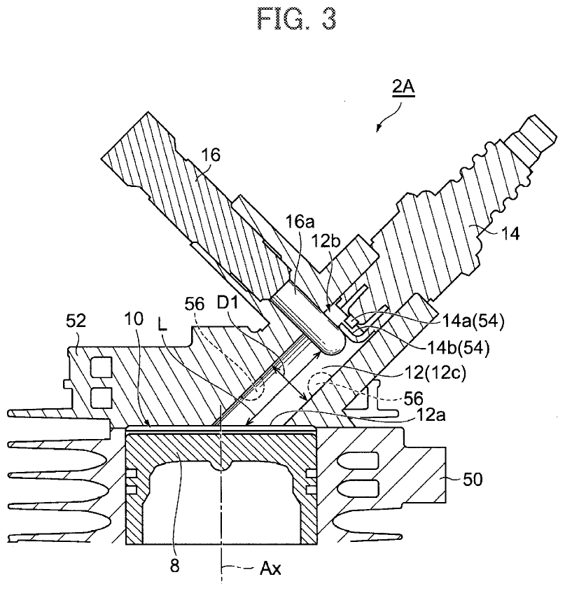

In FIG. 1, the engine body 2 is composed of a cylinder block 50, a cylinder head 52 and the crankcase 26. The cylinder block 50 and the cylinder head 52 may be separate components or may be integrally molded. In the engine body 2A shown in FIG. 3, the cylinder block 50 and the cylinder head 52 are precision cast aluminum alloy components. The cylinder chamber 10 formed by the cylinder head 52 and the top surface of the piston 8 has a flat, substantially rectangular cross-sectional shape, but is not limited to this shape. The cylinder chamber 10 may be of a pent-roof type or hemispherical. Furthermore, although the top surface of the piston 8 shown in FIG. 3 is depicted as a flat surface, it may also have an uneven surface.

The recess 12 has an opening 12a that opens to the cylinder chamber 10, a deep portion 12b, and a tunnel portion 12c that connects the deep portion 12b and the opening 12a. The spark plug 14 and the preheating member 16 are arranged in the deep portion 12b.

In the engine body 2A shown in FIG. 3, a firing portion 54 of the spark plug 14 is composed of a center electrode 14a and an L-shaped ground electrode 14b. The preheating member 16 is composed of a well-known glow plug. The preheating member 16 is turned on at the time of cold engine start-up to heat the firing portion 54 and its surroundings. The preheating member 16 is not limited to the glow plug. Any means capable of directly heating the firing portion 54 and its surroundings can be used as the preheating member 16.

As can be seen most clearly in FIG. 3, the recess 12 of the engine body 2 (2A) in FIG. 3 has a tubular shape, typically a substantially cylindrical shape. The recess 12 may also have an elliptical cross-sectional shape. The recess 12 shown in FIG. 3 has the same effective passage cross-sectional area in the longitudinal direction, and its axial direction is inclined with respect to an axis Ax of the cylinder chamber 10, but it may also be parallel to the axis Ax or orthogonal to the axis Ax. The substantially cylindrical recess 12 may also have a curved shape in the longitudinal direction.

The volume of the recess 12 may be determined based on the compression ratio of the two-stroke engine to be implemented, taking into consideration the shape of the cylinder chamber 10. Although the compression ratios that can be implemented vary slightly depending on the type of fuel, such as gasoline, kerosene, diesel, or alcohol fuel (methanol, ethanol), they are between 6 and 18, preferably between 12 and 15, and the most common compression ratios for two-stroke engines today are between 6 and 8.

Due to its engine characteristics, the two-stroke engine 100 easily transfers heat from burned gas (residual gas) to fresh gas within the interior of the engine. The tunnel section 12c is disposed to utilize this heat to vaporize the fuel contained in the fresh gas. That is, a passage length L of the tunnel section 12c is preferably set so that after the engine 100 starts and warms up, the fuel contained in the fresh gas vaporizes as the fresh gas passes through the tunnel section 12c after entering the tunnel section 12c from the cylinder chamber 10. As a result, when the vaporized fuel enters the deep portion 12b, it decomposes there. Therefore, the fuel can be reliably ignited by the ignition of the spark plug 14.

On the other hand, at the time of a cold start, the heat of the residual gas inside the engine cannot be utilized. Instead of the residual gas heat, the preheating member 16 is used. The preheating member 16 is disposed for the purpose of heating the firing portion 54 of the spark plug 14 and its surroundings. When fuel contained in fresh gas reaches the deep portion 12b at the time of the cold start, the heat generated by the preheating member 16 vaporizes and decomposes the fuel. This ensures that the fuel is securely ignited by the ignition of the spark plug 14.

The tunnel portion 12c is preferably set to have a passage cross-sectional area (diameter D1) such that when the fuel is ignited and the pressure in the deep portion 12b rises suddenly, this pressure rise in the deep portion 12b is immediately transmitted to the cylinder chamber 10. The flame in the deep portion 12b passes through the tunnel portion 12c having the passage length L and enters the cylinder chamber 10, thereby starting combustion in the cylinder chamber 10 and substantially starting the expansion stroke of the engine 100.

Therefore, it is necessary to properly control the timing at which the fuel ignites in the deep portion 12b. In controlling the ignition timing, the passage length L of the tunnel portion 12c is a control factor in the engine 100. Thus, by properly setting the passage length L of the tunnel portion 12c, the expansion stroke of the engine 100 can be properly started.

The passage length L of the tunnel portion 12c is set according to the guidelines described above. If the passage length L of the tunnel portion 12c cannot be sufficiently ensured, the passage length L can be replaced by a structure that reduces the velocity of the gas through the tunnel portion 12c. For this purpose, projections 56 (indicated by imaginary lines in FIG. 3) may be arranged on the inner wall surface of the tunnel portion 12c. The projections 56 may be continuous in the circumferential direction of the tunnel portion 12c, or may be discontinuous. Alternatively, the projections 56 may be scattered over the inner wall surface of the tunnel portion 12c.

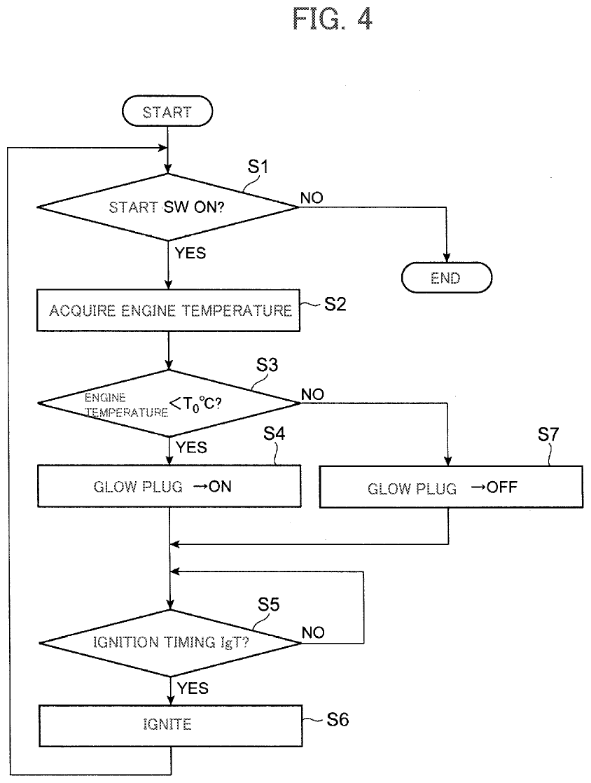

Referring to FIG. 4, the control of the spark plug 14 and pre-heating member 16 by the ECU 42 will be described. When the engine start switch 46 is turned on (S1), information is input from the engine temperature sensor 44 (S2), and it is determined whether the engine temperature is lower than a predetermined value T₀ (S3). If the engine temperature is lower than the predetermined value T₀, it is determined that the engine is in a cold start state, and the process proceeds to step S4, where the pre-heating member 16 is turned on. If it is determined in the next step S5 that the crank angle is at an ignition timing IgT, the spark plug 14 is turned on (S5). When the engine temperature becomes equal to or higher than the predetermined value T₀ as the engine starts, the process proceeds from step S3 to S7, where the pre-heating member 16 is turned off.

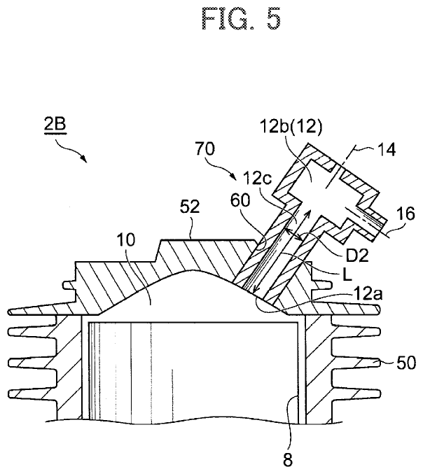

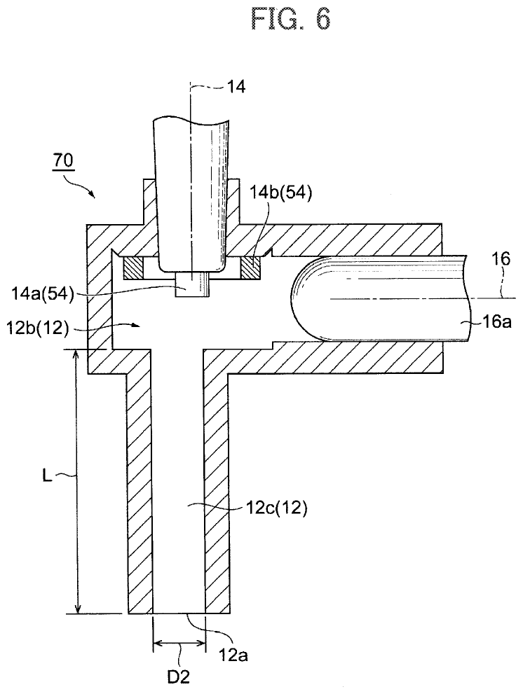

FIGS. 5 and 6 show a modified engine body 2 (2b ). In the description of the illustrated engine body 2B, elements that are substantially the same as those described above are given the same reference numerals. The cylinder head 52 of the engine body 2B is shaped to form a pent-roof-shaped cylinder chamber 10. The shape of the cylinder chamber 10 is also arbitrary in the engine body 2B. The cylinder head 52 has a threaded hole 60 that leads to the top of the cylinder chamber 10, and a recess-forming attachment 70 can be detachably attached later using the threaded hole 60.

The recess-forming attachment 70 has the recess 12 described above, but as can be seen from FIGS. 5 and 6, the diameter of the deep portion 12b is greater than a diameter D2 of the tunnel portion 12c. In other words, referring to FIG. 6, the diameter D2 of the tunnel portion 12c included in the recess-forming attachment 70 is smaller than the deep portion 12b. However, the diameter D2 (FIG. 6) is the same as the diameter D1 (FIG. 3) described above in that it is the diameter through which the pressure increase in the deep portion 12b is immediately transmitted to the cylinder chamber 10 when the fuel is ignited and the pressure in the deep portion 12b rises sharply.

As described above, since the recess-forming attachment 70 is a separate member from the cylinder head 52, the attachment 70 can be made of a material different from the aluminum alloy of the cylinder head 52. The material of the attachment 70 can be selected with heat resistance and heat storage properties in mind. Specific examples of selectable materials include cast iron, stainless steel, and heat-resistant steel.

As can be seen from FIG. 6, the ground electrode 14b of the spark plug 14 has a ring-like shape surrounding the center electrode 14a, but the spark plug 14 (L-shaped ground electrode 14b) in the form of FIG. 3 described above may also be used. Note that the engine body 2A shown in FIG. 3 may also use the spark plug 14 having the ring-shaped ground electrode 14b shown in FIG. 6.

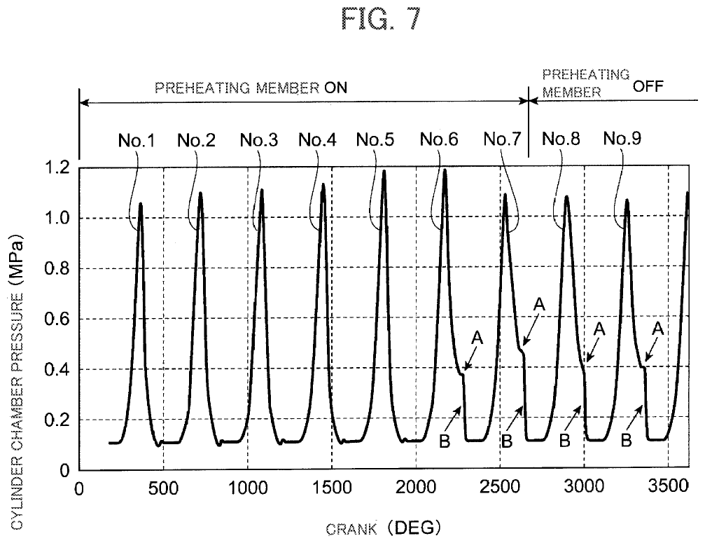

A prototype of the modified engine body 2B (FIGS. 5 and 6) was fabricated and operated, and combustion fluctuations at the time of cold start were confirmed to be within an acceptable range. FIG. 7 shows the simulation results. Referring to FIG. 7, incomplete combustion occurs from the first ignition to the fifth ignition. As can be seen from FIG. 7, the pressure waveforms from the first ignition to the fifth ignition are symmetrical across the peak. In contrast, the pressure waveforms from the sixth ignition onward are asymmetrical across the peak. This indicates that combustion occurred in the cylinder chamber 10. Specifically, when observing the pressure waveforms from the sixth ignition onward, a step A appears as the pressure descends from the peak, and a sudden drop in pressure occurs from step A (as indicated by arrow B). This step A and the subsequent sudden drop in pressure B indicate that the exhaust port 20 (FIG. 1) opens, causing the pressure in the cylinder chamber 10 to suddenly escape from the cylinder chamber 10.

The prototype engine body was a single-cylinder, air-cooled engine with the following specifications:
(i) Displacement: 25 cc
(ii) Compression ratio: 7
(iii) Recess passage length L: 13.2 mm
(iv) Tunnel diameter D2: 6 mm
(v) Fuel: Kerosene (JIS K 2203:2009)

Similar combustion was also confirmed with the following specifications:
(i) Displacement: 25 cc
(ii) Compression ratio: 8
(iii) Recess passage length L: 3.2 mm
(iv) Tunnel diameter D2: 3 mm
(v) Fuel: Kerosene

The present invention includes the following Examples.
(i) It may be a water-cooled two-stroke engine.
(ii) It may be a multi-cylinder two-stroke engine.
(iii) In step S3 of the flowchart in FIG. 4, the on/off of the preheating member 16 is controlled based on the engine temperature detected by the temperature sensor 44. However, instead of controlling the preheating member 16 based on the temperature sensor 44, the preheating member 16 may be turned off when the crankshaft has rotated a predetermined number of times based on the number of rotations of the crankshaft since the engine was started.
(iv) As a modification of (iii) above, the preheating member 16 may be turned off once the engine speed has stabilized after cold start-up.
(v) As a modification of (iii) above, the preheating member 16 may be turned off after a predetermined time has elapsed after cold start-up.
(vi) As a modification of the above (iii), the pre-heating member 16 may be turned off after a predetermined time has elapsed since the engine start switch 46 was turned on and the pre-heating member 16 was turned on. For example, this predetermined time may be 5 to 15 seconds.
(vii) A fuel injection valve may be used instead of the carburetor 30 shown in FIG. 1. The fuel injection valve may be disposed in any one of the crankcase 26, the scavenging passages 24, or the cylinder chamber 10. The fuel injection valve may also be disposed at a position from the opening 12a of the recess 12 to the middle of the tunnel portion 12c in the longitudinal direction.
(viii) The two-stroke engine 100 according to the present invention can be used as a power source for portable working machines such as brush cutters, blowers, and chainsaws, and can also be used as a power source for portable generators.
(ix) The two-stroke engine 100 according to the present invention can be used as a power source for a stationary generator.
100 Two-stroke engine
2 Engine body
8 Piston
10 Cylinder chamber
12 Recess
12a Opening of recess
12b Deep portion of recess
12c Tunnel portion of recess
14 Spark plug
16 Preheating member
18 Scavenging ports
24 Scavenging passages
26 Crankcase
54 Firing portion of spark plug
56 Projection
70 Recess-forming attachment
L Passage length of tunnel portion
D1, D2 Diameter of tunnel portion

What is claimed is:

1. A two-stroke engine comprising:
a cylinder chamber in which a piston reciprocates;
an intake port that is opened and closed by the piston;
an exhaust port opened and closed by the piston;
scavenging passages communicating with a crankcase;
scavenging ports connected to the scavenging passages and opened and closed by the piston, wherein fresh gas is supplied from the intake port to the crankcase, the fresh gas pre-compressed in the crankcase being supplied to the cylinder chamber through the scavenging passages and the scavenging ports, thereby scavenging the cylinder chamber; and
a recess leading to the cylinder chamber, wherein the recess comprises:
an opening that opens to the cylinder chamber;
a deep portion;
a tunnel portion having a passage length and connecting the deep portion and the opening;
a spark plug disposed in the deep portion; and
a preheating member for heating a firing portion of the spark plug and its surroundings.

2. The two-stroke engine of claim 1, wherein the tunnel portion has a tubular shape.

3. The two-stroke engine of claim 2, wherein the tunnel portion has, on its inner surface projections for reducing the velocity of gas flowing through the tunnel portion.

4. The two-stroke engine of claim 1, further comprising a carburetor, wherein an air-fuel mixture produced in the carburetor is supplied to the crankcase.

5. The two-stroke engine of claim 1, further comprising a fuel injection valve disposed in any one of the crankcase, the scavenging passages, the cylinder chamber, or a portion from the opening of the recess to the middle of the tunnel portion in the longitudinal direction.

6. The two-stroke engine of claim 1, wherein the recess is formed in a cylinder head portion.

7. The two-stroke engine of claim 1, wherein the recess is formed by a recess-forming attachment that is detachably attached to the cylinder head portion.

8. The two-stroke engine of claim 1, wherein the fuel used is any one of kerosene, diesel, and alcohol fuel.

9. The two-stroke engine of claim 1, wherein the tunnel portion has a diameter that allows immediate transmission of a rise in pressure in the deep portion to the cylinder chamber when fuel is ignited in the deep portion and the pressure in the deep portion rises.

10. The two-stroke engine of claim 1, wherein the tunnel portion has a passage length that allows fuel contained in fresh gas that has entered the tunnel portion from the cylinder chamber to evaporate as the fresh gas passes through the tunnel portion after the engine has started and warmed up.
